(19) United States
(12) Patent Application Publication
(10) Pub. No.: US 2025/0320344 A1
(43) Pub. Date: Oct. 16, 2025

(54) DEVICE AND METHOD FOR DEGRADATION OF A NON-BIODEGRADABLE COMPONENT

(71) Applicant: Mirza Faizan, Irving, TX (US)

(72) Inventors: Mirza Faizan, Irving, TX (US); Riday S Jogani, Sunnyvale, TX (US); Yusuf Marwat, Allen, TX (US); Arjun Kommidi, Plano, TX (US); Sheik Ahamed Azigar Ali, Frisco, TX (US); Basel Koujan, Southlake, TX (US); Omar Ismail, Southlake, TX (US); Gautam Surapaneni, Irving, TX (US); Ayat Faizan, Irving, TX (US); Saadia Asaf, Aligarh (IN); Mansoor Hasan Khan, Aligarh (IN); Mirza Rizwan, Patna (IN); Ashaz Haque, Patna (IN); Aarifa Fatima, Patna (IN)

(21) Appl. No.: 18/635,164

(22) Filed: Apr. 15, 2024

(51) Int. Cl. C08J 11/10

(52) U.S. Cl. CPC C08J 11/10; C08J 2300/30

(57) ABSTRACT

The present disclosure provides a device for biodegrading a non-biodegradable component. The device comprises a first chamber comprising a first end to adjustably connect to the component and a second end, an elongate tube disposed within the first chamber and extending across a length of the first chamber, a second chamber connected to the second end, a metallic elongate tube disposed within the second chamber storing biological degrading agents such that a metallic membrane is disposed between the metallic elongate tube and the elongate tube, and a striking element having a first side provided with a pointed metal head and facing the metallic membrane and a flat second side. The striking element is movably arranged in the elongate tube to move across the length of the first chamber to rupture the metallic membrane and cause release of the biological degrading agents into the elongate tube for biodegradation.

### TECHNICAL FIELD

The present invention relates generally to a device for biodegradation, and more particularly the present invention relates to a device and a method for biodegrading a non-biodegradable component using biological degrading agents.

### BACKGROUND

Plastic pollution has emerged as a significant environmental concern, with widespread accumulation of plastic waste posing serious ecological and human health risks. Traditional methods of plastic disposal, such as landfilling and incineration, contribute to environmental degradation and are unable to effectively manage the escalating volume of plastic waste generated globally. As a result, there is an urgent need for sustainable and eco-friendly solutions to address the plastic pollution crisis.

Biological degradation of plastic offers a promising approach to mitigate plastic pollution by harnessing the natural enzymatic activities of microorganisms to break down plastic polymers into simpler compounds. Various biological degrading strains, such as bacterial or fungal strains, have been identified for their ability to degrade different types of plastic, including polyethylene (PE), polypropylene (PP), and polyethylene terephthalate (PET), through the secretion of plastic-degrading enzymes such as esterases, lipases, and proteases.

However, the practical application of biological-based plastic degradation faces challenges related to the scalability, efficiency, and containment of the biological degrading strains in real-world environments. Existing methods rely on the dispersal of degrading strains onto plastic surfaces or the incorporation of bacteria into bioreactors, which may suffer from limited efficacy, and poor retention of bacterial activity. Therefore, there is a need to overcome drawbacks associated with the conventional methods of biological degradation of plastics.

### SUMMARY

The present disclosure provides a device and a method for biological degradation of non-biological component.

In one aspect, a device for biodegrading a non-biodegradable component is provided. The device comprises a first chamber comprising a first end to adjustably connect to the non-biodegradable component and a second end opposite to the first end. The device further comprises an elongate tube disposed within the first chamber such that the elongate tube extends across a length of the first chamber. The device further comprises a second chamber connected to the second end of the first chamber. The device further comprises a metallic elongate tube disposed within the second chamber such that the metallic elongate tube is at least substantially aligned with the elongate tube and a metallic membrane is disposed therebetween. The metallic elongate tube stores biological degrading agents. The device further comprises a striking element having a first side provided with a pointed metal head and facing the metallic membrane and a flat second side opposite to the first side. The striking element is movably arranged within the elongate tube to move longitudinally across the length of the first chamber to rupture the metallic membrane. The rupturing of the metallic membrane causes release of the biological degrading agents into the elongate tube for biodegradation of the non-biodegradable component.

According to some embodiments, the metallic elongate tube stores a color fluid. Further, the rupturing of the metallic membrane causes release of the color fluid into the elongate tube.

According to some embodiments, the metallic elongate tube defines a first section to store the biological degrading agents and a second section to store the color fluid.

According to some embodiments, the first chamber is transparent, and the release of the color fluid into the elongate tube is visible through the first chamber.

According to some embodiments, the visibility of the color fluid through the first chamber indicates an end of useful life of the non-biodegradable component.

According to some embodiments, the non-biodegradable component is made of plastic.

According to some embodiments, each of the first chamber, the elongate tube, the second chamber and the striking element is made of plastic.

According to some embodiments, the non-biodegradable component is a toothbrush. Further, the striking element is operable to move longitudinally within the elongate tube of the first chamber to rupture the metallic membrane due to use of the toothbrush.

According to some embodiments, the release of the biological degrading agents within the elongate tube causes biodegradation of at least one of: the first chamber, the elongate tube, the second chamber and the striking element.

According to some embodiments, the movement of the striking element within the elongate tube causes the pointed metal head to strike the metallic membrane. Moreover, the metallic membrane is adapted to be ruptured at least after a predetermined number of strikes of the pointed metal head on the metallic membrane.

According to some embodiments, the pointed metal head is made of stainless steel.

According to some embodiments, the first end of the first chamber is provided with a fastening means to connect the first chamber with the non-biodegradable component.

In another aspect, a method for biodegrading a non-biodegradable component is provided. The method comprises providing a first chamber comprising a first end to adjustably connect to the non-biodegradable component and a second end opposite to the first end. The method further comprises providing an elongate tube disposed within the first chamber such that the elongate tube extends across a length of the first chamber. The method further comprises providing a second chamber connected to the second end of the first chamber. The method further comprises providing a metallic elongate tube disposed within the second chamber such that the metallic elongate tube is at least substantially aligned with the elongate tube and a metallic membrane is disposed therebetween. The metallic elongate tube stores biological degrading agents. The method further comprises providing a striking element having a first side provided with a pointed metal head and facing the metallic membrane and a flat second side opposite to the first side. The striking element is movably arranged within the elongate tube to move longitudinally across the length of the first chamber to rupture the metallic membrane. The rupturing of the metallic membrane causes release of the biological degrading agents into the elongate tube for biodegradation of at least the non-biodegradable component.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 shows a schematic illustration of a device for biodegrading a non-biodegradable component, in accordance with an embodiment of the present disclosure;

FIG. 2 illustrates a schematic illustration of an arrangement of the device for biodegrading with the non-biodegradable component, in accordance with an embodiment of the present disclosure;

FIG. 3 illustrates a front view of the of the device for biodegrading of FIG. 1, in accordance with an embodiment of the present disclosure; and

FIG. 4 illustrates a flowchart of a method for biodegrading a non-biodegradable component, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

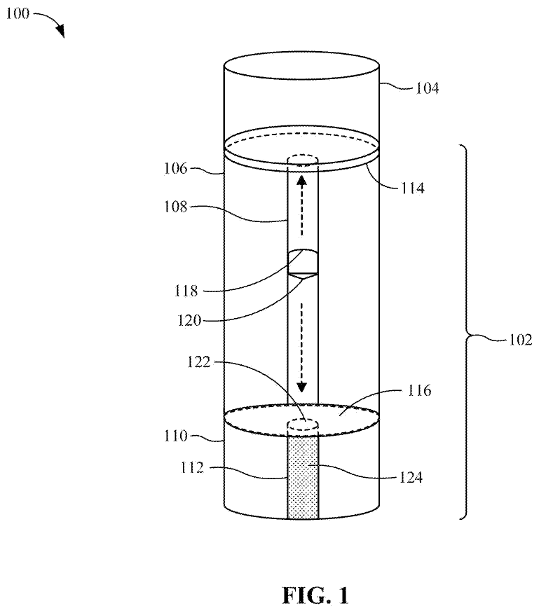

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 4, a brief description concerning the various components of the present disclosure will now be briefly discussed. Reference will be made to the figures showing various embodiments of a device for biodegrading a non-biodegradable component.

Embodiments of present disclosure provide a device for degrading or biodegradation of a non-biodegradable component, such as a plastic component. Recognizing the prevalent challenges arising due to high amount of use of plastic objects followed by unmindful disposal of such plastic objects, the techniques described in the present disclosure provide a device that degrades plastic object right after use. Subsequently, accumulation of plastic waste, such as in landfills and sometimes in city and/or forest premises, can be prevented. Further, the ease and other benefits of use of such plastic objects is still maintained as user is still able to use the plastic objects.

The present disclosure relates to a device designed for the efficient degradation of plastic waste, i.e., a non-biodegradable component, using biological degrading agents capable of metabolizing plastic materials. The device contains a metallic tube to store the biological degrading agents in a controlled environment, and a mechanism for facilitating the release of the biological degrading agents when a useful life of the non-biodegradable component is complete.

FIG. 1 shows a schematic illustration 100 of a device 102 for biodegrading a non-biodegradable component 104, in accordance with an embodiment of the present disclosure. The device 102 includes a first chamber 106, an elongate tube 108, a second chamber 110 and a metallic elongate tube 112.

In an example, the first chamber 106 and the second chamber 110 may be hollow cylindrical containers. Each of the first chamber 106 and the second chamber 110 may have two parallel bases.

In this regard, the two parallel bases of the first chamber 106 may correspond to a first end 114 and a second end 116. The two parallel bases, i.e., the first end 114 and the second end 116, may be flat. The first chamber 106 includes the first end 114 to adjustably connect to the non-biodegradable component 104 and the second end 116 opposite to the first end 114.

In an example, the first end 114 of the first chamber 106 is provided with a fastening means (not shown) to connect the first chamber 106 with the non-biodegradable component 104. In particular, an inner surface of the first end 114 may face the hollow container of the first chamber 106 while an outer surface of the first end 114 may have a fastening means for connecting the first chamber 106 to the non-biodegradable component 104. Similarly, an inner surface of the second end 116 may face the hollow container of the first chamber 106 while an outer surface of the second end 116 may have another fastening means for connecting the first chamber 106 to the second chamber 110. Examples of the fastening means may include, but are not limited to, hinges, screws, rivets, latches, bolts, clips, clamps, ties, and harnesses. In certain other cases, the fastening means may be implemented using joints, such as tongue and groove joint, lap joint, dowel joint, dado joint, dovetail joint, mortise and tenon joint, miter joint, rabbet joint, click joint, solvent bonding, welding, snap fit joint, press fit joint, etc.

The embodiments of the present disclosure describe the connection between the first chamber 106 and the non-biodegradable component 104 and/or the connection between the first chamber 106 and the second chamber 110 using the fastening means, however, this should not be construed as a limitation. In an example, the first chamber 106, the second chamber 110 and/or the non-biodegradable component 104 may be extruded using a same die such that the first chamber 106, the second chamber 110 and/or the non-biodegradable component 104 are connected to each other.

In addition, the shape of the first chamber 106 and the second chamber 110 to be cylindrical is only exemplary and should not be construed as a limitation. In other cases, the shape of the first chamber 106 and/or the second chamber 110 may be cuboid, frustum, inverted frustum, etc.

Continuing further, the device 102 includes the elongate tube 108 disposed within the first chamber 106 such that the elongate tube 108 extends across a length of the first chamber 106. For example, the elongate tube 108 is a hollow cylindrical tube disposed within the hollow container of the first chamber 106. For example, the elongate tube 108 and the first chamber 106 may be coaxial. Subsequently, a length of the elongate tube 108 may correspond to the length of the first chamber 106 while a radius of the elongate tube 108 is substantially smaller than a radius of the first chamber 106.

The second chamber 110 is connected to the second end 116 of the first chamber 106. The second end also includes the two parallel bases, such that the two parallel bases are also opposing flat ends. For example, a first end side of the second chamber 110 is connected to the outer surface of the second end 116 of the first chamber 106 while a second end side of the second chamber 110 defines an end point of the device 102. In certain cases, the second end of the second chamber 110 may be tapered or end-rounded.

Further, the device 102 includes the metallic elongate tube 112 disposed within the second chamber 110. The metallic elongate tube 112 is made of, for example, a metal or an alloy. The metallic elongate tube 112 is at least substantially aligned with the elongate tube 108. For example, the metallic elongate tube 112 may also be hollow cylindrical tube. In an example, a radius of the cylindrical elongate tube 108 and the cylindrical metallic elongate tube 112 may be same or equal. Further, a base of the cylindrical elongate tube 108 may align with a base of the cylindrical metallic elongate tube 112. Moreover, a metallic membrane 122 is disposed between the metallic elongate tube 112 and the elongate tube 108. For example, the metallic membrane may be a metallic sheet of predefined thickness that may be placed at the base of the cylindrical elongate tube 108 that aligns with the base of the cylindrical metallic elongate tube 112. In other words, hollow cavity of the elongate tube 108 may be separated from hollow cavity of the metallic elongate tube 112 using the metallic membrane 122.

In an example, the metallic elongate tube 112 is made of aluminum. For example, inside and/or outside surface of the metallic elongate tube 112 is coated with a protective layer to prevent corrosion. Moreover, the metallic elongate tube 112 is cylindrical in shape.

The metallic elongate tube 112 stores biological degrading agents 124. Pursuant to the present disclosure, the biological degrading agents 124 are microorganisms that can decompose plastics. These microorganisms may possess enzymes that enable them to break down chemical bonds in plastics, converting them into simpler molecules that can be utilized as nutrients. In an example, the biological degrading agents 124 may be bacteria, fungi, or certain types of algae. In an example, the biological degrading agents 124 is Pestalotiopsis microsporia.

The device 102 comprises a striking element 118 having a first side provided with a pointed metal head 120 and facing the metallic membrane and a flat second side opposite to the first side. In an example, the striking element 118 may be a hollow or a solid cylinder that is disposed within the elongate tube 108 of the first chamber 106. The striking element 118 is movably arranged within the elongate tube 108 to move longitudinally across the length of the first chamber 108. The two parallel base or two opposing sides of the striking element 118 are referred to as the first side and the second side. For example, the second side is flat such that when the striking element 118 moves, the second side touches or comes in contact with a surface of a base of the elongate tube 108. Alternatively, the first side is provided with the pointed metal head 120, therefore the first side is pointed. Subsequently, when the striking element 118 moves, the first side touches or comes in contact with the metallic membrane 122 disposed between the elongate tube 108 and the metallic elongate tube 112.

In operation, the non-biodegradable component 104 may be a utility equipment to be used by a user. Subsequently, when the user uses the non-biodegradable component 104, the non-biodegradable component 104 may be moved back and forth. The striking element 118 is movably arranged in the elongate tube 108. Due to the back and forth movement of the non-biodegradable component 104, the striking element 118 also moves in the elongate tube 108 and strikes the metallic membrane 122. In due course of time, the pointed metal head 120 of the striking element 118 ruptures the metallic membrane 122 that leads to release of the biological degrading agents 124. In particular, the biological degrading agents 124 are released into the elongate tube 108. Subsequently, the biological degrading agents 124 cause biodegradation of the non-biodegradable component 104. For example, the biological degrading agents 124 may biodegrade or breakdown plastic-based non-biodegradable component 104 into organic matter.

In an example, the non-biodegradable component 104 is made of plastic. In addition, the first chamber 106, the elongate tube 108, the second chamber 110 and the striking element 118 are made of plastic. Subsequently, when the biological degrading agents 124 are released, they may biodegrade all components of the device 102 as well as the non-biodegradable component 104, except the pointed metal head 120, the metallic membrane 122 and the metallic elongate tube 112. Therefore, only metal part of the device 102 is left after the degradation that may be recycled. In this manner, any waste due to the use of the non-biodegradable component 104 is eliminated thereby preventing plastics getting into landfills or into soil that causes soil pollution or soil toxicity.

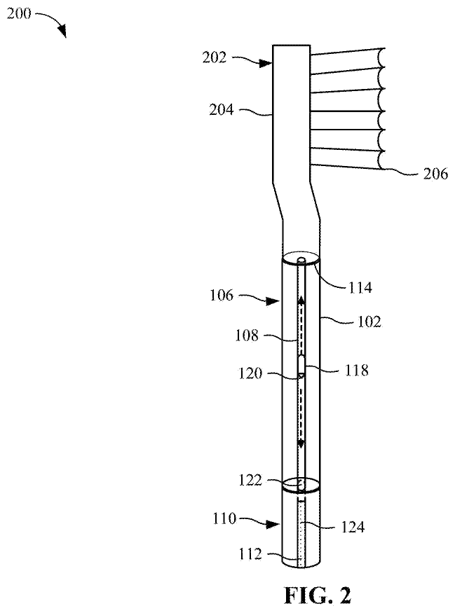

FIG. 2 illustrates a schematic illustration 200 of an exemplary arrangement of the device 102 for biodegrading with the non-biodegradable component 104, in accordance with an embodiment of the present disclosure. FIG. 2 is explained in conjunction with FIG. 1.

Pursuant to present example, the non-biodegradable component 104 is a toothbrush 202. Toothbrushes contribute to plastic waste due to the materials they are typically made of is primarily plastic. A typical plastic toothbrush has a handle made of polypropylene (PP) or other types of plastic, and nylon bristles. Therefore, both the components, i.e., the handle and the bristles, are non-biodegradable. Since toothbrushes are generally replaced every few months, the accumulation of discarded toothbrushes contributes to large amount of overall plastic waste problem. Due to the large number of toothbrushes, such as in order of billions in a year in certain countries, toothbrush waste is a global concern.

The device 102 of the present disclosure addresses the problem associated with the toothbrush waste. For example, the device 102 is arranged with the toothbrush 202 that comprises a head 204 and bristles 206. For example, the head 204 is made of plastic, such as polypropylene (PP), high-density polyethylene (HDPE), low-density polyethylene (LDPE), and thermoplastic elastomers (TPE). Moreover, the bristles 206 are also made of plastic, such as nylon. Further, the device 102 causes biodegradation or degradation of plastic of the toothbrush 202, i.e., the head 204 and the bristles 206, as well as plastic component of the device 102.

In an example, the device 102 is arranged with the toothbrush 202 such that the device 102 forms a handle of the toothbrush 202. Alternatively, the device 102 may be coated with additional layers of plastic and/or rubber to make the toothbrush 202 ergonomic and provide grip.

In operation, while a user uses the toothbrush 202, the pointed metal head 120 of the striking element 118 may keep on striking the metallic membrane 122. In particular, the striking element 118 is operable to move longitudinally within the elongate tube 108, in other words, across the length of the elongate tube 108 of the first chamber 106. After a predefined number of strikes the pointed metal head 120 on the metallic membrane 122, the metallic membrane 122 may get ruptured. Subsequently, due to use of the toothbrush for a given number of time leading to the predefined number of strikes of the pointed metal head 120 on the metallic membrane 122, the metallic membrane 122 gets ruptured.

The metallic elongate tube 112 stores the biological degrading agents 124. Once the metallic membrane 122 gets ruptured, the biological degrading agents 124 are released into the elongate tube 108. For example, the biological degrading agents 124 may first degrade the plastic of the striking element 118 and the elongate tube 108. Once the elongate tube 108 is degraded, the biological degrading agents 124 may be released into the first chamber 106 and may thus degrade the first chamber 106. Thereafter, the non-biodegradable component 104 or the head 204 and the bristles 206, as well as the second chamber 110 may get degraded. In the end, the pointed metal head 120, the metallic elongate tube 112 and the metallic membrane 122 are left, which may be recycled and re-used.

In an example, the first chamber 106 and the second chamber 110 of the device 102 may form the handle of the toothbrush 202. For example, the first chamber 106 and the second chamber 110 of the device 102 are made of plastic. In an example, at least the first chamber 106 of the device 102 is transparent, such as transparent plastic. For example, the transparent first chamber 106 may be made of polycarbonate, or polymethyl methacrylate (PMMA).

It may be noted, the depiction of the non-biodegradable component 104 to be toothbrush 202 is exemplary, and should not be construed as a limitation. Other examples of the non-biodegradable component 104 may include, but are not limited to, cosmetic products (such as lipstick)

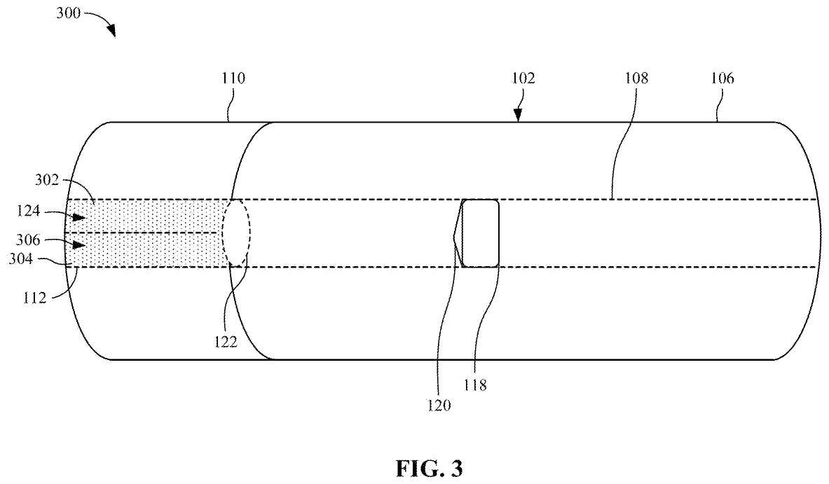

FIG. 3 illustrates a front view 300 of the of the device 102 for biodegrading, in accordance with an embodiment of the present disclosure. FIG. 3 is explained in conjunction with FIG. 1 and FIG. 2.

In an example, the device 102 may form a handle of the non-biodegradable component 104, such as the toothbrush 202. Further, the device 102 comprises the first chamber 106, the second chamber 110, the elongate tube 108 disposed within the first chamber 106, and the metallic elongate tube 112 disposed within the second chamber 110. For example, the elongate tube 108 and the metallic elongate tube 112 are separated through the metallic membrane 122.

Further, the device 102 comprises the striking element 118 having the pointed metal head 120. As the device 102 is moved, i.e., used, the striking element 118 may strike the metallic membrane 122. For example, the metallic membrane 122 has a thickness such that it may not collapse or tear for a predefined number of strikes from the striking element 118. In an example, with the hand movement of a user, causing the striking element 118 to move along the length of the hollow elongate tube 108 and hit the breakable metallic membrane 122. Further, after a predefined number of strikes, the metallic membrane 122 may get ruptured and cause release of the biological degrading agents 124 into the elongate tube 108.

In particular, striking element 118 moves within hollow space of the elongate tube 108 along with the hand movement of the user, causing the striking element 118 to move along a length of the elongate tube 108 and hit the metallic membrane 122. In an example, the predefined number of strikes required to break the breakable metallic membrane 122 is adjustable, such as by adjusting the thickness of the metallic membrane 122 and/or changing chemical composition of metal to be used for manufacturing of the metallic membrane 122.

In accordance with an embodiments, the metallic elongate tube 112 stores a color fluid 306. In an example, the metallic elongate tube 112 defines a first section 302 to store the biological degrading agents 124 and a second section 304 to store a color fluid 306. In an example, when the metallic membrane 122 gets ruptured or punctured, content of both the first section 302 and the second section 304 may get released into the elongate tube 108. Accordingly, the rupturing of the metallic membrane 122 causes release of the color fluid 306 into the elongate tube 108.

In an example, the first chamber 106 is transparent. For example, the first chamber 106 is made of transparent plastic. Moreover, the elongate tube 108 is also made of transparent plastic. Subsequently, when the metallic membrane 122 gets ruptured the biological degrading agents 124 gets released from the first section 302 of the metallic elongate tube 112 and the color fluid 306 gets released from the second section 304 of the metallic elongate tube 112. As the first chamber 106 and the elongate tube 108 are transparent, the release of the color fluid 306 into the elongate tube 108 is visible through the first chamber 106. In an example, the visibility of the color fluid 306 through the first chamber 106 indicates an end of useful life of the non-biodegradable component 104. For example, when the non-biodegradable component 104 is the toothbrush 202, as the color fluid 306 becomes visible from outside of the first chamber 106, a user of the toothbrush 202 gets an indication that the useful life of the toothbrush is complete. This may also indicate to the user that the biological degrading agents 124 have been released and thus the user should stop using the toothbrush 202. Based on the indication due to the color fluid 306, the user may dispose the toothbrush 202. The biological degrading agents 124 may cause biodegradation of the toothbrush 202 including, for example, the head 204, the bristles 206, the first chamber 106, the elongate tube 108, the second chamber 110 and the striking element 118. To this end, the metallic membrane 122, the metallic elongate tube 112 and the pointed metal head 120 are not biodegraded but may be recycled. Subsequently, the release of the biological degrading agents 124 within the elongate tube 108 causes biodegradation of the first chamber 106, the elongate tube 108, the second chamber 110 and the striking element 118.

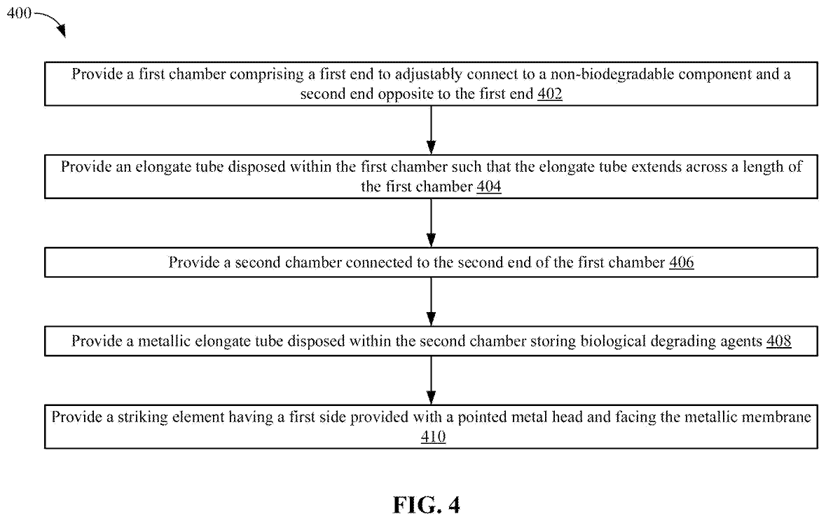

FIG. 4 illustrates a flowchart 400 of a method for biodegrading the non-biodegradable component 104, in accordance with an embodiment of the present disclosure. FIG. 4 is explained in conjunction with FIG. 1, FIG. 2, and FIG. 3.

At 402, the first chamber 106 is provided. The first chamber 106 comprises the first end 114 to adjustably connect to the non-biodegradable component 104 and a second end 116 opposite to the first end 114. The first chamber 106 is provided as part of the device 102.

At 404, the elongate tube 108 is provided. The elongate tube 108 is disposed within the first chamber 106 such that the elongate tube 108 extends across a length of the first chamber 106.

At 406, a second chamber 110 is provided. The second chamber 110 is connected to the second end 116 of the first chamber 106. In an example, the first chamber 106 and the second chamber 110 are manufactured separately, such that the second chamber 110 is joined with the first chamber 106. In another example, the first chamber 106 and the second chamber 110 may be extruded together.

At 408, the metallic elongate tube 112 is provided. The metallic elongate tube 112 is disposed within the second chamber 110 such that the metallic elongate tube 112 is at least substantially aligned with the elongate tube 108. Moreover, a metallic membrane 122 is disposed between the elongate tube 108 and the metallic elongate tube 112. The metallic elongate tube 112 stores biological degrading agents 124. In an example, the biological degrading agents 124 may be Pestalotiopsis microsporia. In another example, the biological degrading agents 124 may be bacteria, such as pseudomonas, bacillus, and streptomyces. In yet another example, the biological degrading agents 124 may be fungi, such as aspergillus, and penicillium. In certain other cases, the biological degrading agents 124 may be algae or actinomycetes.

At 410, the striking element 118 is provided in the device 102. The striking element 118 has a first side provided with the pointed metal head 120 and facing the metallic membrane 122 and a flat second side opposite to the first side. The striking element 118 is movably arranged within the elongate tube 108 to move longitudinally across the length of the first chamber 106 to rupture the metallic membrane 122. The rupturing of the metallic membrane 122 causes release of the biological degrading agents 124 into the elongate tube 108 for biodegradation of the non-biodegradable component 104 as well as components of the device 102.

In accordance with an example, the movement of the striking element 118 within the elongate tube 108 causes the pointed metal head 120 to strike the metallic membrane 122. Further, the metallic membrane 122 is adapted to be ruptured at least after a predetermined number of strikes of the pointed metal head 120 on the metallic membrane 122. In an example, the pointed metal head 120 is made of stainless steel.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A device for biodegrading a non-biodegradable component, comprising:
a first chamber comprising a first end to adjustably connect to the non-biodegradable component and a second end opposite to the first end;
an elongate tube disposed within the first chamber such that the elongate tube extends across a length of the first chamber;
a second chamber connected to the second end of the first chamber;
a metallic elongate tube disposed within the second chamber such that the metallic elongate tube is at least substantially aligned with the elongate tube and a metallic membrane is disposed therebetween, wherein the metallic elongate tube stores biological degrading agents; and
a striking element having a first side provided with a pointed metal head and facing the metallic membrane and a flat second side opposite to the first side, such that the striking element is movably arranged within the elongate tube to move longitudinally across the length of the first chamber to rupture the metallic membrane, wherein the rupturing of the metallic membrane causes release of the biological degrading agents into the elongate tube for biodegradation of the non-biodegradable component.

2. The device of claim 1, wherein the metallic elongate tube stores a color fluid, and wherein the rupturing of the metallic membrane causes release of the color fluid into the elongate tube.

3. The device of claim 2, wherein the metallic elongate tube defines a first section to store the biological degrading agents and a second section to store the color fluid.

4. The device of claim 2, wherein the first chamber is transparent, and wherein the release of the color fluid into the elongate tube is visible through the first chamber.

5. The device of claim 4, wherein the visibility of the color fluid through the first chamber indicates an end of useful life of the non-biodegradable component.

6. The device of claim 1, wherein the non-biodegradable component is made of plastic.

7. The device of claim 1, wherein each of the first chamber, the elongate tube, the second chamber and the striking element is made of plastic.

8. The device of claim 1, wherein the non-biodegradable component is a toothbrush, and wherein the striking element is operable to move longitudinally within the elongate tube of the first chamber to rupture the metallic membrane due to use of the toothbrush.

9. The device of claim 1, wherein the release of the biological degrading agents within the elongate tube causes biodegradation of at least one of: the first chamber, the elongate tube, the second chamber and the striking element.

10. The device of claim 1, wherein the movement of the striking element within the elongate tube causes the pointed metal head to strike the metallic membrane, and wherein the metallic membrane is adapted to be ruptured at least after a predetermined number of strikes of the pointed metal head on the metallic membrane.

11. The device of claim 1, wherein the pointed metal head is made of stainless steel.

12. The device of claim 1, wherein the first end of the first chamber is provided with a fastening means to connect the first chamber with the non-biodegradable component.

13. A method for biodegrading a non-biodegradable component, the method comprising:
providing a first chamber comprising a first end to adjustably connect to the non-biodegradable component and a second end opposite to the first end;
providing an elongate tube disposed within the first chamber such that the elongate tube extends across a length of the first chamber;
providing a second chamber connected to the second end of the first chamber;
providing a metallic elongate tube disposed within the second chamber such that the metallic elongate tube is at least substantially aligned with the elongate tube and a metallic membrane is disposed therebetween, wherein the metallic elongate tube stores biological degrading agents; and
providing a striking element having a first side provided with a pointed metal head and facing the metallic membrane and a flat second side opposite to the first side, such that the striking element is movably arranged within the elongate tube to move longitudinally across the length of the first chamber to rupture the metallic membrane, wherein the rupturing of the metallic membrane causes release of the biological degrading agents into the elongate tube for biodegradation of at least the non-biodegradable component.

14. The method of claim 13, further comprising
providing a color fluid within the metallic elongate tube, wherein the rupturing of the metallic membrane causes release of the color fluid into the elongate tube, and wherein the release of the color fluid into the elongate tube is visible through the first chamber.

15. The method of claim 14, further comprising
providing a first section within the metallic elongate tube to store the biological degrading agents and a second section to store the color fluid.
